(19) United States
(12) Patent Application Publication
(10) Pub. No.: US 2026/0130325 A1
(43) Pub. Date: May 14, 2026

(54) Germinating And Growth Tray Assembly For Plant Seeds

(71) Applicant: Donald A Felizberto, Westport, MA (US)

(72) Inventor: Donald A Felizberto, Westport, MA (US)

(21) Appl. No.: 18/997,338

(22) PCT Filed: Jul. 21, 2023
(86) PCT No.: PCT/US2023/070691

§ 371 Date: Jan. 21, 2025

Related U.S. Application Data
(60) Provisional application No. 63/391,471, filed on Jul. 22, 2022.

(51) Int. Cl. A01G 9/029; A01C 1/02

(52) U.S. Cl. CPC A01G 9/0293; A01C 1/02; A01G 9/0295

(57) ABSTRACT

Tray assemblies for germinating and growing plant seeds are provided. Preferably, the tray assemblies comprise outer trays, inner trays, inner divider frames, and covers. The dividers or partitions of the inner divider frame form a plurality of compartments across the frame. Each compartment is configured to receive at least one seed for germination and growth. Seeds are placed in in the compartments and allowed to float in water and/or sit in humid air. A cover is placed over the divider frame to block-out light and retain heat. Once the seeds have germinated, they can be placed in a growth medium that helps promote the plant growth and development.

### CROSS-REFERENCE TO RELATED APPLICATIONS

The application claims the benefit of U.S. Provisional Patent Application No. 63/391,471 filed Jul. 22, 2022, the entire disclosure of which is hereby incorporated by reference.

### BACKGROUND OF THE INVENTION

### Field of the Invention

The present invention relates generally to tray assemblies for storing, germinating and growing plant seeds. More particularly, the invention relates to tray assemblies comprising different compartments. Seeds are placed in the compartments and allowed to float in water and/or sit in humid air. A cover is placed over the tray assembly to block-out light and retain heat. Once the seeds have germinated, they can be placed in a growth medium that helps promote the growth and development of plants.

### Brief Review of the Related Art

In recent years, “at-home” seed germination and plant growth systems have become popular. These systems allow “at-home” gardeners to germinate seeds and grow plants in the comfort and privacy of their own homes or greenhouses. Typically, these traditional systems use water, paper towels/plastic bags, and a dark cabinet or closet. The seeds are allowed to soak in water for about 18 to about 24 hours. Then, the seeds are wrapped in paper towels and placed in plastic bags for a sufficient time period, for example, about 3 to about 5 days. The seeds are kept in a dark cabinet or closet during the germination process. The resulting seedlings may be transferred to planting pots containing soil and plant nutrients to promote plant development.

Although some conventional seed germination and growth systems may be generally effective in creating a favorable environment, there are some drawbacks with such systems. For example, the seeds can be physically damaged in some traditional systems and the growth medium may not be adequately controlled. The heat and moisture levels may be insufficient in some cases; while, in other cases, there may be excessive heat and moisture. It is difficult to regulate heat and moisture levels in some traditional systems. Another problem with many traditional systems is there is no feasible way for properly organizing and labeling the seeds. Thus, when multiple seed varieties are placed in the planting pot or other container, the seeds can blend together and there can be harmful effects. Sorting through the seed and plants can be time-consuming and seed germination may not occur or be delayed. If there is some plant growth, these plants may not properly develop. In contrast to some traditional tray systems, the tray assemblies of this invention provide an effective means for labeling and organizing the seeds and plants. The tray assemblies of the present invention provide additional features, benefits and advantages as described further below.

### BRIEF DESCRIPTION OF THE DRAWINGS

The novel features that are characteristic of the present invention are set forth in the appended claims. However, the preferred embodiments of the invention, together with further objects and attendant advantages, are best understood by reference to the following detailed description in connection with the accompanying drawings in which:

FIG. 1 is a top view of one embodiment of the tray assembly of the present invention showing a first outer container tray, a second inner tray, and an inner divider frame;

FIG. 1A is a top view of the first outer container tray shown in FIG. 1;

FIG. 1B is a top view of the first outer container tray and second inner tray sub-assembly shown in FIG. 1;

FIG. 1C is a top view of the second inner tray sub-assembly and inner divider frame shown in FIG. 1;

FIG. 2 is a perspective view of one embodiment of an inner divider frame for the tray assembly of the present invention;

FIG. 2A is a top view of the inner divider frame shown in FIG. 2;

FIG. 3 is a top view of a second embodiment of an inner divider frame for the tray assembly of the present invention;

FIG. 4 is a a perspective view showing the inner divider frame being inserted into the inner tray and a locking mechanism for the divider frame and inner tray.

FIG. 5 is a perspective view of one embodiment of the inner divider frame showing the beveled corners of the divider frame;

FIG. 6 is a side elevational view of one embodiment of the inner tray showing the projecting foot segments;

FIG. 7 is a perspective view of one embodiment of the inner tray and a cover for the tray assembly, wherein the cover is placed under the inner tray;

FIG. 8 is a top perspective view of a tray assembly showing one embodiment of a cover placed over the trays;

FIG. 9 is a bottom perspective view of a tray assembly showing one embodiment of a base for the trays;

FIG. 10 is a side elevational view of three tray assemblies stacked on top of each other;

FIG. 11 is a top view of another embodiment of a tray assembly of the present invention;

FIG. 12 is a perspective view of one embodiment of a tweezer tool of the present invention is shown.

FIG. 13 is a schematic diagram showing the tweezer tool of FIG. 12 being inserted into a tray in accordance with the present invention;

FIG. 14 is a side elevational tool of the tweezer tool of FIG. 12;

FIG. 15 is a perspective view of one embodiment of a split-pot of the present invention;

FIG. 16 is a top view of one embodiment of a split-pot handling tool of the present invention;

FIG. 17 is a schematic diagram showing the split-pot handling tool of FIG. 16 removing a split-pot from the inner partitioned tray;

FIG. 18 is a bottom perspective view of a tray assembly showing one embodiment of a base for the tray assembly, wherein the base includes a ring notch for inserting a heat pad sensor;

FIG. 18A is a close-up view of the heat pad sensor extending through the ring notch shown in FIG. 18B;

FIG. 18B is a bottom perspective view of the tray assembly shown in FIG. 18, and further showing a heat pad sensor inserted through the ring notch;

FIG. 19 is a perspective view of one embodiment of the first outer container tray wherein the container tray includes low and high-water fill indicators;

FIG. 20 is a perspective view of one embodiment of a split-pot of the present invention;

FIG. 21 is a perspective view of one embodiment of a split-pot handling tool of the present invention; and

FIG. 22 is a schematic diagram showing the split-pot handling tool of FIG. 21 removing a split-pot from the inner partitioned tray.

### DETAILED DESCRIPTION OF THE INVENTION

The present invention provides tray assemblies for germinating and growing plant seeds. The tray assemblies comprise different compartments.

### Circular-Shaped Trays

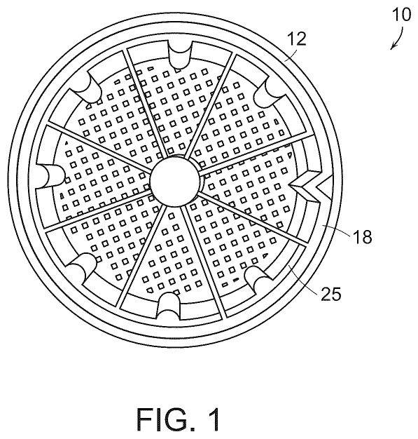

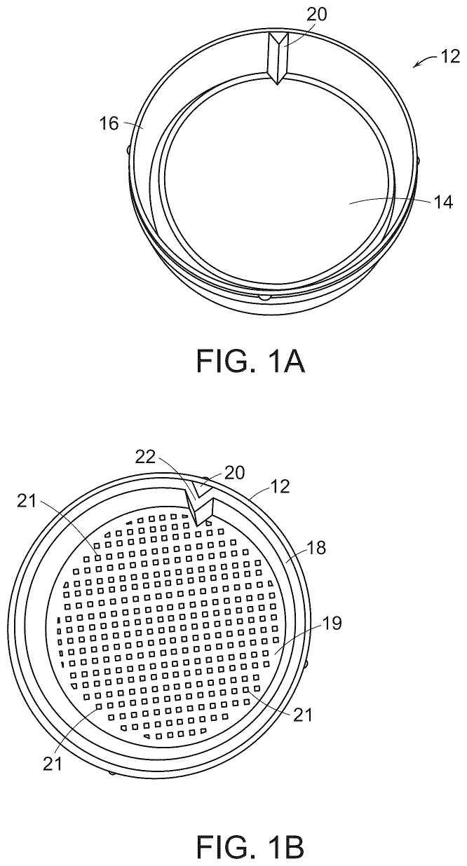

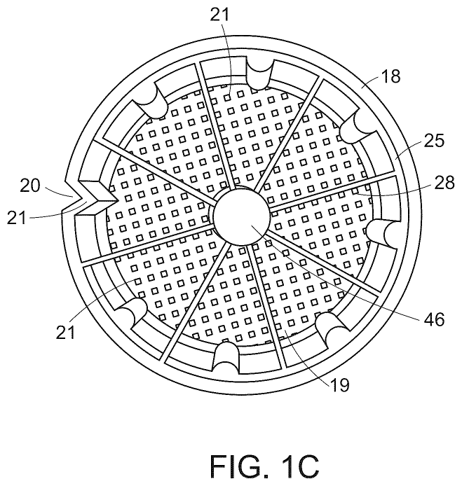

Referring to the Figures, where like reference numerals are used to designate like elements, and particularly FIG. 1, one embodiment of the tray assembly of the present invention is shown and generally indicated at (10). The tray assembly (10) is shown having a first (outer) container tray (12). As shown in FIG. 1A, the outer container tray (12) has a floor or bottom portion (14) and an outer perimeter wall (16). A second (inner tray) (18) is structured so that it can be fitted in the first container tray (12) as shown in FIG. 1B. The second (inner tray) (18) also can be referred to as a strainer tray. The inner (strainer) tray contains a floor or bottom portion (19) containing perforations or small apertures (21). Turning to FIG. 1C, an inner divider frame (25) can be fitted into the inner (strainer) tray (18). The partitions or dividers (28) of the divider frame can have perforations or small apertures (81) so that air and water can pass between the tray compartments as discussed further below.

In practice, the inner (strainer) tray (18) is first placed into the outer tray (12) so that it rests on the floor (14) of the outer tray (12). In one preferred embodiment, the strainer can be adapted to receive a lab filter paper. The filter paper is placed on the floor or bottom portion (19). The filter paper helps keep the taproots from growing through the strainer holes and is used to separate precipitates from the water. As shown in FIG. 1A, in one embodiment, the outer tray (12) contains a male member (20) that fits into a notch (22) of the first (outer) tray so that the male member interlocks with the notch. The male member and notch (20, 22) are complementary and interlock with each other. In this manner, the inner and outer trays (18, 12) are tightly secured together. The inner and outer trays (18, 12) are locked in place. In this example, the male member (20) has a V-shaped structure and the complementary notch (22) is also V-shaped. However, it should be understood that the male member (20) and notch (22) can have any suitable cross-sectional shapes such as, for example, circular, oval, triangular, square, pentagonal, hexagonal, heptagonal, octagonal, and the like. It is also recognized that other locking mechanisms for interlocking the inner and outer trays (18, 12) can be used in accordance with this invention.

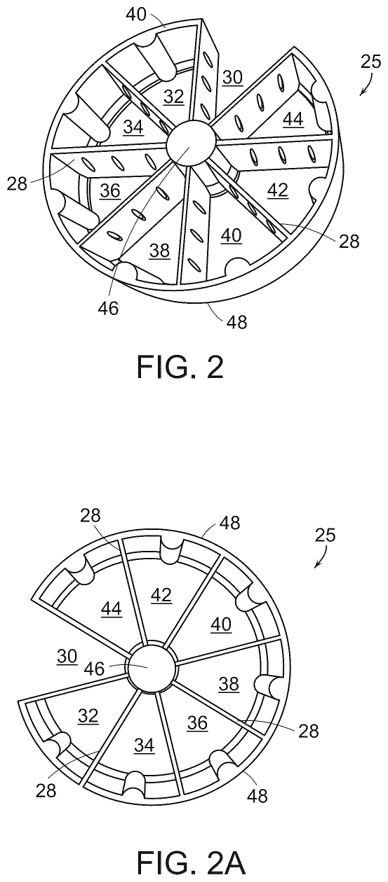

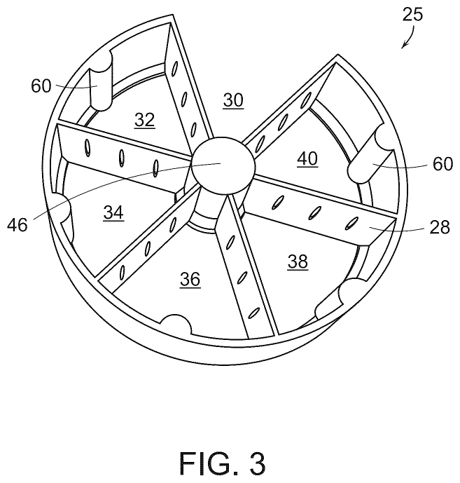

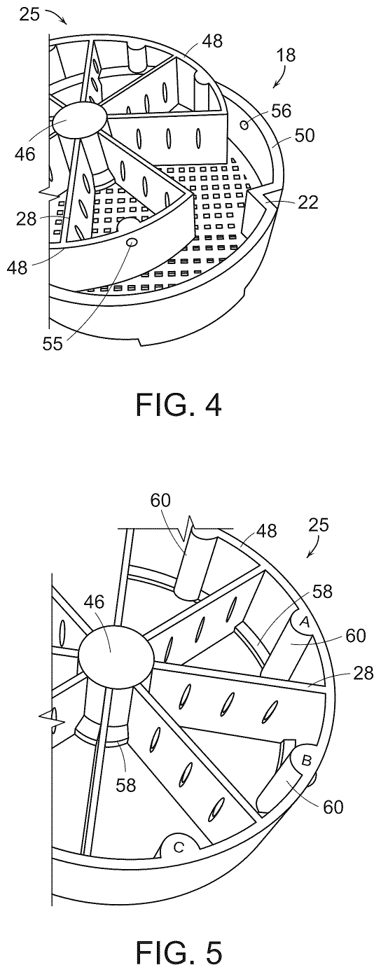

Referring to FIGS. 2, 2A, and 3, in one preferred embodiment, an inner divider frame (25) is fitted into the inner tray (18). The inner divider frame (25) contains dividers (partitions) (28) that separate the interior of the tray into different compartments. In FIGS. 2 and 2A, there are eight (8) compartments (30, 32, 34, 36, 38, 40, 42, and 44). In FIG. 3, the divider frame (25) contains six (6) compartments. The dividers (28) radiate outwardly from a central connector column (46) and extend to an outer perimeter wall (48). The central connector (46) also can be referred to as a hub connector. In one embodiment, the outer perimeter wall (48) of the divider frame (25) does not extend around compartment (30). Rather, as shown in FIG. 4, the compartment (30) in this example is defined by the radiating partitions (25) and the outer perimeter wall (50) of the inner (strainer) tray (18). It should be understood that this embodiment, wherein the outer perimeter wall (48) of the divider frame (25) does not extend around compartment (30) is only one embodiment and is shown for illustration purposes only. In other embodiments, the outer perimeter wall (48) of the divider frame (25) extends completely around all of the compartments including compartment (30).

The inner divider frame (25) can be locked into the inner (strainer) tray (18) using any suitable locking mechanism. Referring to FIG. 4, for example, the inner divider frame (25) can include a pair of relatively small, circular locking buttons or pins (55). The outer perimeter wall (50) of the inner (strainer) tray (18) contains complementary apertures (56) adapted to receive the locking pins (55). The pins (55) fall into alignment with the respective apertures (56). At this point, the pins (55) are fitted into the apertures (56), thus locking the divider frame (25) and inner (strainer) tray (18) in place. Furthermore, as shown in FIG. 5, the inner divider frame (25) can include a beveled lower rim (58). These beveled segments (58) help prevent seeds from getting trapped in the bottom corners of the divider frame (25).

As discussed above, the inner divider frame (25) may be considered as having a pie-like structure with separate wedge-shaped “slices” (compartments) (30, 32, 34, 36, 38, 40, 42, and 44). One or more seeds may be placed in each compartment. In this way, the seeds can be organized, and the individual compartments can protect the seeds. The individual compartments keep the seeds separated and prevent them from mixing with each other. In one preferred embodiment, as shown in FIG. 5, the outer perimeter wall (48) of the divider frame (25) contains column members (60) that project inwardly and into the different compartments. The top surface of these compartment columns (60) can be marked accordingly so that the seeds are not misplaced. For example, the columns (60) can be marked with different symbols, logos, names, initials, letters, numerals, and other indicia. The first compartment column (60) may be marked with a first letter, the second compartment column (60) marked with a second letter, the third compartment column (60) marked with a third letter, and the like.

If desired, the inner divider frame (25) can be removed from the inner (strainer) tray (18). For example, referring back to FIG. 1B, the inner divider frame (25) can be removed so that the tray assembly only includes the inner tray (18) and outer tray (12). In practice, to remove the divider frame (25), the user grasps the hub connector (46) between his/her thumb and index finger and pinches the hub connector (46). This squeezing action loosens the divider frame (25). The user then pulls upwardly on the divider frame (25); and the frame is removed from the inner (strainer) tray (18).

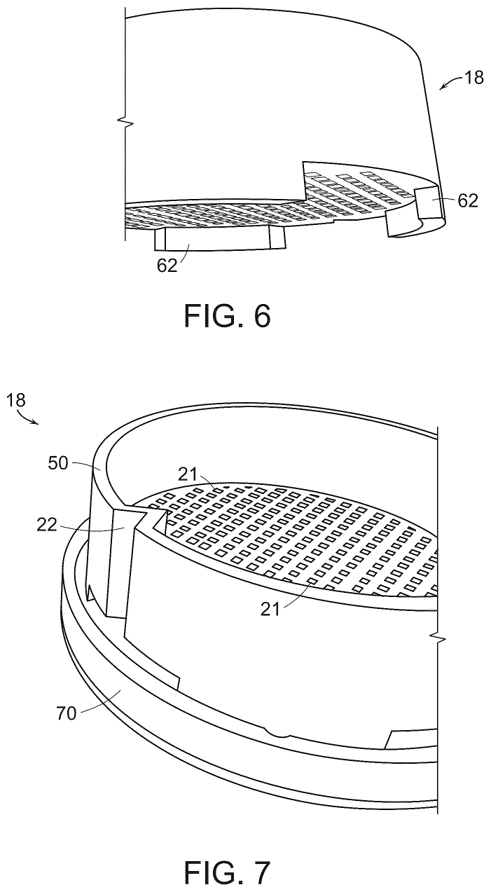

Turning to FIG. 6, the inner (strainer) tray (18) preferably contains projecting foot segments (62) that help provide extra stability. The projecting feet (62) also allows for a greater amount of water to collect under the bottom of the tray (18). There is also an increased volume of air generated under the inner (strainer) tray (18). This increased volume of water helps provide greater water-soaking of the seeds. The greater air flow also helps with seed germination. If desired, silica or humidity packs, which are commonly used in seed storage, can be placed under the inner (strainer) tray (18). Also, as shown in FIG. 7, the cover (70) of the tray assembly can be flipped over and placed under the inner (strainer) tray (18) to collect any excess water that drains off.

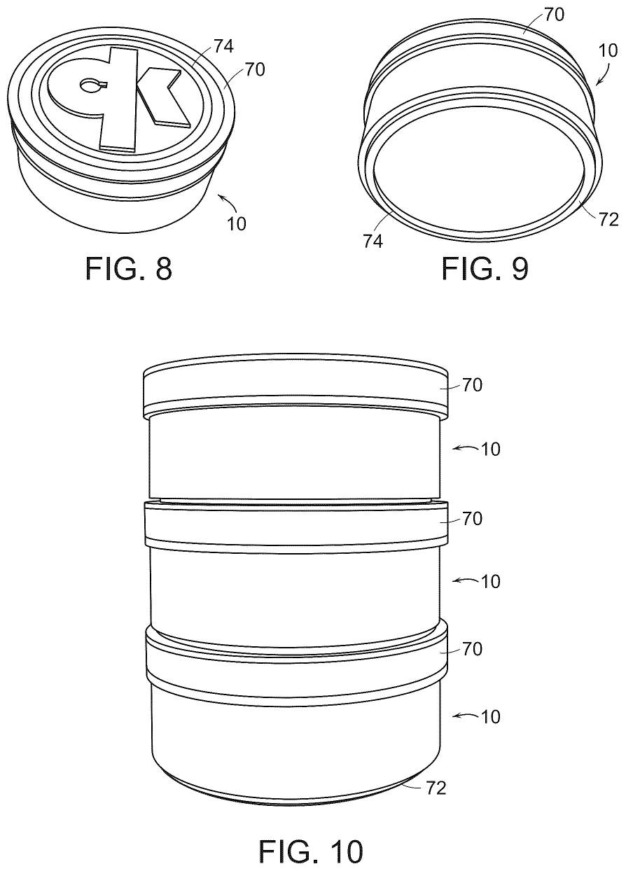

The individual tray assemblies with their overlying covers (70) and underlying bases (72) are also configured so they can be stacked on top of each other. The covers (70) can be printed with symbols, logos, names, initials, letters, numerals, and other indicia. For example, as shown in FIGS. 8, 9, and 10, the cover (70) and base can contain raised trim portions (74) that extend upwardly. The protruding trim portions (74) form a geometric pattern. There are channels or grooves positioned between the protruding trim portions (74). Referring to FIG. 10, in one example, a first tray assembly (10) is placed on the ground surface. Then a second tray assembly (10) is placed on top of the first tray. Finally, a third tray assembly (10) is placed on top of the second tray. In this arrangement, the bottom rim portion (base) (72) of the second tray (10) engages with and fits into the recessed areas in the top cover (70) of the first tray (10). Then, the bottom rim portion (74) (base) of the third tray engages with and fits into the recessed areas (74) in the top cover of the second tray. In this manner, multiple trays (10) can be securely stacked on top of each other. This stacking feature is advantageous for handling and storing the trays (10).

### Dividers

The dividers (partitions) (28) that separate the interior of the tray into different compartments (30, 32, 34, 36, 38, 40, 42, and 44) are advantageous features of the present invention. In conventional trays that do not contain such dividers or interior compartments, the seeds can be mixed with each other. This can cause seeds to be misplaced and misidentified. In contrast to such traditional systems, the compartments of the tray assemblies of the present invention keep the seeds separated and prevent them from mixing with each other. As discussed above, the individual compartments can be marked with symbols, letters, numbers, and the like so that the seeds are not misplaced. The compartments can be marked with projecting columns (60) or in any other suitable manner. It is recognized that the number of dividers and compartments may vary without departing from the scope of the invention. That is, the tray may contain any desired number of dividers, for example, one, two, three, four, five, six, and the like. Different inner divider frames (25) may be inserted into the inner tray (18) to divide the inner tray into a desired number of compartments. In this way, the tray assemblies can be customized to contain preferred dividers and compartments.

As discussed above, an inner divider frame (25) can be fitted into the inner (strainer) tray (18). Thus, in this example, the dividers (28) are fixed in place. The compartments (30, 32, 34, 36, 38, 40, 42, and 44) have a fixed size and their dimensions cannot be modified.

However, in other embodiments, an inner divider frame (25) is not used. Rather, independent dividers (partitions) can be inserted into the inner (strainer) tray (18). Each of these separate and distinct dividers can be removed individually. The individual dividers can be removed so the size of the compartments can be changed. Separate dividers can be added or removed, as desired, to expand or reduce the sizes of the individual compartments.

Although the inner tray (18) is primarily described and illustrated herein as having eight separate compartments (30, 32, 34, 36, 38, 40, 42, and 44), it is recognized that the number, size, and shape of the compartments are for illustration purposes only. The number, size, and shape of the compartments can vary without departing from the scope of the invention. For example, in FIG. 3, the tray is shown as having six compartments. In other embodiment, the tray may contain only two, three, four, or five compartments.

In one embodiment, the seeds are placed in the compartments. As described further below and as shown in FIG. 12, tweezers (75) having cupped ends (77) can be used for placing the seeds in the compartments. The outer container tray (12) is filled with water, preferably distilled water and the inner divider frame (25)/inner (strainer) tray (18) sub-assembly containing the seeds in the compartments is slowly placed in the outer container tray (12). In this step, the seeds are allowed to float and/or sit in humid air. The seeds sit on the floor (19) of the inner (strainer) tray (18) containing relatively small perforations (21). The seeds are allowed to float in the water for about 18 to about 24 hours. Then, the water is drained. The water can be drained by removing the side drain plug of the tray. The tweezers (77) can be used for removing the plug by inserting the tabbed end (79) into the plug and turning it counter-clockwise. After this step, a small layer of fresh water covering the floor is added to the outer container tray (12). With heat, this water creates humid air within the tray. The moisture level is increased. The cover (70) of the tray helps to trap the heat and moisture and keeps the seeds from drying out for about 3 to about 5 days. In addition, the cover (70) helps to prevent light rays from penetrating into the tray assembly (10) and reaching the seeds. The covered tray assembly can be placed on a heat pad. In one preferred example, the temperature of the heat pad is kept at approximately 75° to 80° F. for about 18 to about 24 hours. Additional steps in the seed germination and growth process are described in further detail below.

The cover (70) and tray assembly (10) are complementary to each other and there is preferably a locking mechanism to keep the cover (70) in place. For example, the cover (70) can be snap-fitted into the tray assembly (10) using a ball and socket locking mechanism. In this way, the cover is tightly secured to the tray assembly; and the seeds/seedlings are kept in a dark and controlled environment. The tightly sealed cover provides several benefits. For example, the cover prevents light from transmitting into the tray. The cover helps to lock in heat and humidity for improved seed germination. The close tolerance of the cover and tray helps to keep the cover tightly sealed in place. This tight sealing helps prevent the seeds from spilling out of the tray even if the tray is tilted or dropped.

### Rectangular-Shaped Trays

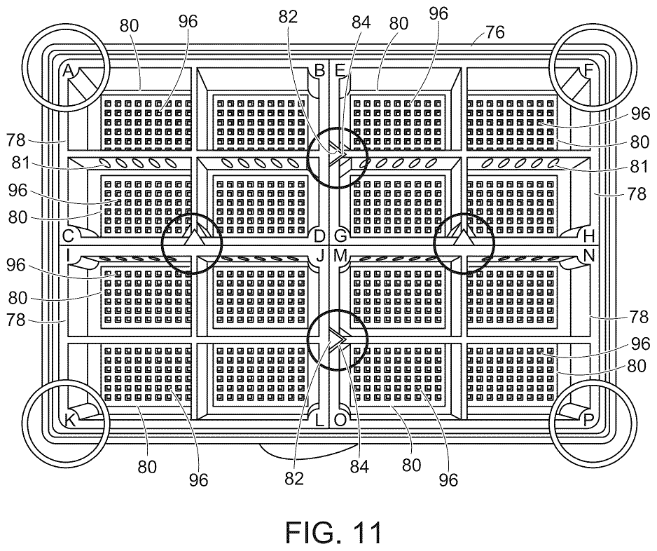

Turning to FIG. 11, in other embodiments, the outer container tray (76) can have a rectangular shape. Four separate inner trays (78) can be fitted into the outer rectangular tray (76). Each of the four separate trays (78) has four individual pods or compartments (80). These four inner trays (78) can interlock with each other so that the trays stay in place. Any suitable locking mechanism can be used to lock the trays together. For example, as described above, a tray may contain a male member (82) that fits into a notch (84) of an adjacent tray so that the male member interlocks with the notch. The male member (82) and notch (84) are complementary and interlock with each other. As shown in FIG. 11, in this example, the male member has a V-shaped structure (82) and the complementary notch is also V-shaped (84). In this manner, the four inner trays (78) are tightly secured to each other. The inner trays (78) are locked in place using this locking mechanism. Also, the outside corners of the outer tray (76) and inner trays (78) are preferably rounded. In FIG. 11, these rounded corners are marked with the letters, “A”, “F”, “P”, and “K”. The inner trays (78) are configured so they only can be fitted in one position in the outer tray (76). The floors and walls of the individual pods (80) can have small apertures (81) so that air and water can pass between the pods. As described above, seeds and water are placed in the pods (80) to generate and support seed germination.

One or more seeds may be placed in each pod (80). As discussed above, in this way, the seeds can be organized, and the individual pods (80) can protect the seeds. The individual pods (80) keep the seeds separated and prevent them from mixing with each other. As shown in FIG. 11, the pods can be marked with different symbols, logos, names, initials, letters, numerals, and other indicia. The top surfaces of the pods can be marked. For example, the first pod (80) may be marked with the letter, “A”, the second pod (80) marked with the letter, “B”, and the third pod (80) marked with the letter, “C”, and the like.

Also, although the outer tray (76) is shown in FIG. 11 as having four separate inner trays (78), wherein each tray has four individual pods (compartments) (80), it is recognized that the number, size, and shape of the outer tray, inner trays and pods can vary. For example, the rectangular outer tray (76) might contain only two inner trays (78), and each tray might only contain two pods (80). In another example, the outer tray (76) might contain four separate inner trays (78), wherein and each tray might contain only one pod (80).

### Germination and Growth of Seeds

As discussed above, in the germination process, the tray assembly (10) can be first filled with water, preferably distilled water, and the seeds are allowed to float in the water. Then, the cover (70) can be placed over the tray assembly (10) to block-out light and help control moisture and heat levels. The seeds are left in the water for about 18 to about 24 hours. If the seeds are left in the water for longer time periods, the seeds may not get sufficient oxygen and may “drown.” Referring back to FIG. 7, the cover (70) for the tray assembly can be flipped over; and the inner (strainer) tray (18) containing the seeds may be placed onto the flipped cover (70). In this way, any excess water from the inner (strainer) tray (18) can drain off and be collected in the cover (70). This excess water then can be discarded; and a small amount of fresh water is added back into the outer container tray (12). The inner divider frame (25)/inner (strainer) tray (18) containing the seeds in the compartments can be placed back into the outer container tray (12). The cover (70) is placed back on the tray assembly (10) and the closed tray assembly can be placed on a heating pad having a temperature in the range of about 75° to 80° F. After a sufficient period of time (typically about 3 to about 5 days), the germinated seedlings with a tap root having a length of about one-quarter (¼) to about one-half (½) inches can be removed using tweezers (75) as described further below. Then, the germinated seedlings can be planted in a tray having a good growth medium including soil and nutrients.

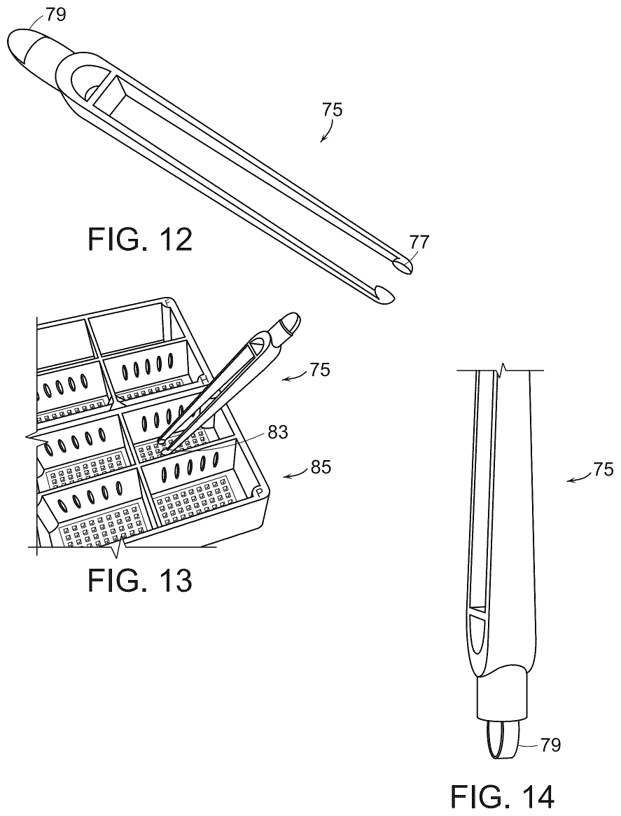

Referring to FIGS. 12, 13, and 14, one embodiment of a tweezer tool (75) of the present invention is shown. The tweezer can be used to grip a seed and place it in the germination tray. The tweezers (75) have cupped ends (77). As shown in FIG. 13, these cupped ends (77) provide a secure and yet delicate grip when grabbing and placing the seed (83) into the germination tray (85). The tweezers (75) are less rigid than traditional tweezers. The tweezers (75) of this invention are also effective when holding the germinated seed, and avoiding the taproot, when moving the germinated seed into the split-pots. Using these tweezers (75) helps a person to avoid touching the seeds with their hands. This helps prevent contamination of the seeds.

One advantageous feature of the tweezers (75) of this invention is the opposing end (79) of the tweezers can be pressed into the growing medium in the tray. A user can apply pressure on the first end (77) so that the opposing second end (79) penetrates in the growing medium. This forms a plug in the growing medium and makes a hole for the seed and a slot for the taproot. The tweezers (75) also can be used to remove the drain plug on the outer tray (12) as discussed above.

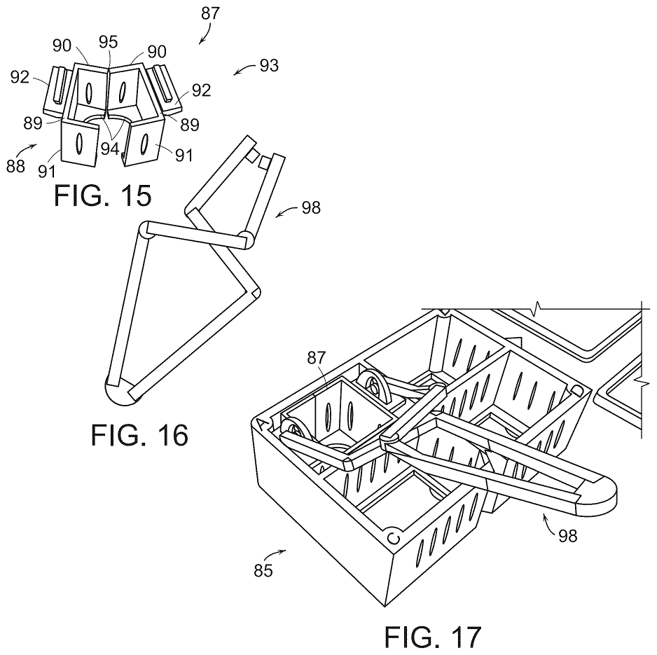

Referring to FIG. 15, an interlocking split-pot (87) of this invention is shown. The split-pot (87) comprises a first frame (88), wherein the first frame (88) comprises a first sidewall panel (89). The first sidewall panel (89) is joined to a first rear-end wall panel (90) and first front-end wall panel (91). The first sidewall panel (89) also includes a projecting first handle panel (92). The split-pot further comprises a second frame (93), wherein the second frame (93) comprises a second sidewall panel (89). The second sidewall panel (89) is joined to a second rear-end wall panel (90) and second front-end wall panel (91). The second sidewall panel (89) also includes a projecting second handle panel (92).

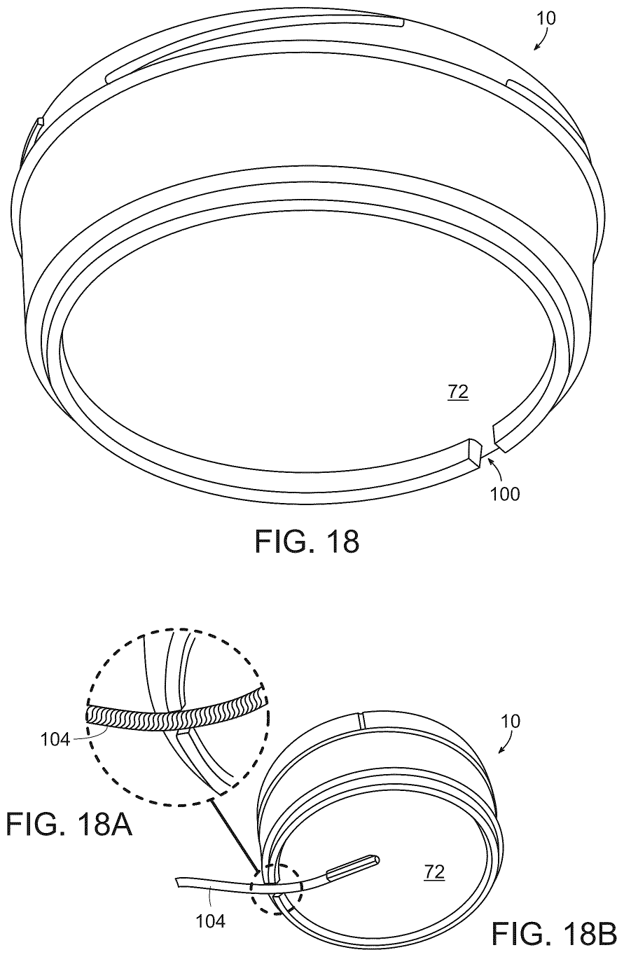

As shown in FIGS. 15, 16, and 17, the first and second frames (88, 93) also include lower (bottom) end panels (94). Each bottom panel (94) has a semi-circle cut-away section. The first and second rear-end wall panels are joined together by a hinge (95). Thus, when the split-pot (87) is closed by pressing the first and second front end-wall panels (91) towards each other so that they make contact, the bottom panel has a full circle cut-out section. The split-pots (87) can have elongated openings in their wall panels for air pruning. These openings help promote root growth downwardly through the circular cut-out section of the bottom panel. A split-pot handling tool (98) can be used for handling the split-pots (87) in the tray (85) as shown in FIGS. 16 and 17.

Turning back to FIG. 11, another important feature of the tray systems of the present invention is the “false bottoms” of the inner (strainer) trays (78). That is, the floors (96) of the individual tray pods (compartments) (80) can be “false bottoms.” Once the seeds have germinated, the false bottoms (96) are removed to avoid plant roots from growing through the strainer bottoms. This step is done before inserting the split-pots (87) into the tray. It is important to prevent plant roots from growing through the strainer bottoms, because these roots can cause severe damage when trying to remove the split-pot/plant. Removing the false bottoms (96) allows the seedling to grow roots through the bottom of the split-pot directly to the bottom of the inner tray where a small amount of water is stored. Thus, the false bottoms (96) of the strainer trays make it easier to transition from the germination phase to the growth and development phase in the tray system. After the false bottoms (96) have been removed, the split-pots (87), which are filled with a growth medium containing soil, nutrients, and other additives, is inserted into the tray. The tray systems of this invention provide an ideal environment for storage, seed germination and plant growth. Another advantageous feature is that once the tray system has been used, it can be cleaned. The tray system is dishwater and cold storage safe. Once the tray system has been cleaned, it can be packed away. The clear vented dome of the system can be flipped upside down and all of the parts can be placed inside for storage. The closed tray is then fitted on top of the clear dome and stored away.

It should be understood that the tray assemblies and systems for plant seed germination and growth, components of the tray assemblies, constructions, materials, methods, and the like described and illustrated herein represent only some embodiments of the invention. It is appreciated by those skilled in the art that various changes and additions can be made to the assemblies, systems, components, constructions, materials, methods, techniques, and the like without departing from the spirit and scope of this invention. For example, referring to FIG. 18, another embodiment of a base (72) for the tray assembly (10) is shown, wherein the base includes a ring notch (100) for inserting a heat pad sensor (104). When the covered tray assembly (10) is placed on the heat pad sensor (104), humid air can be generated, and such humid conditions can help in the seed germination and growth process.

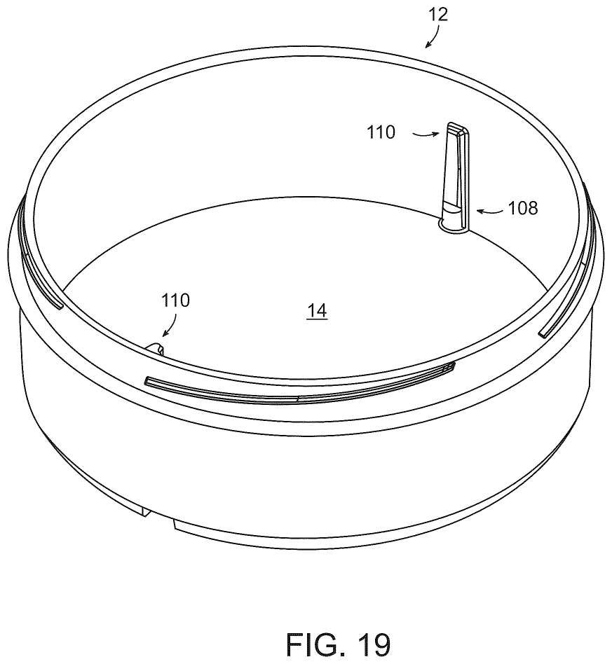

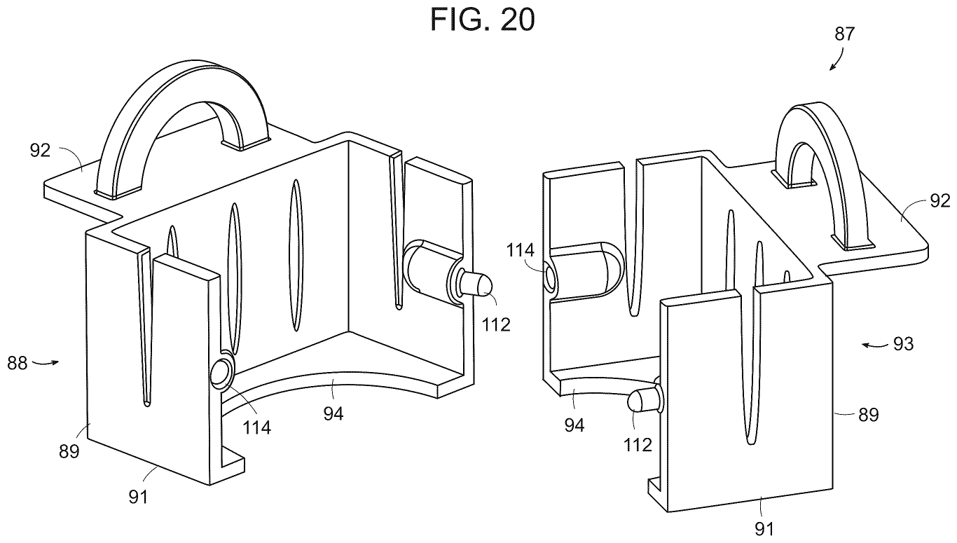

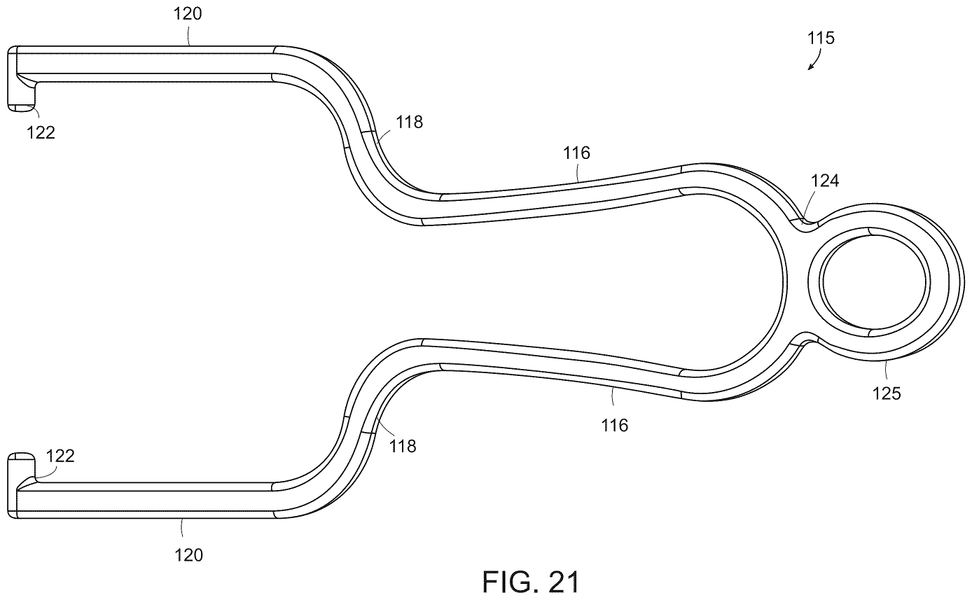

Turning to FIG. 19, another embodiment of the outer container tray (12) is shown, wherein the interior of the container tray includes low (108) and high (110) water fill-indicators. The low and high-water indicators (108, 110) provide a quick and easy way to know the amount of water in the container tray (12) to collect under the bottom of the tray (18). Controlling the volume of water leads to more efficient control over the water-soaking of the seeds in the tray. The low and high-water indicators (108, 110) quickly and effectively show the level of water in the tray.

In FIG. 20, the split-pot (87) comprises a first frame (88), wherein the first frame (88) comprises a first sidewall panel (89). The first sidewall panel (89) is joined to a first rear-end wall panel and first front-end wall panel (91). The first sidewall panel (89) also includes a projecting first handle panel (92). The split-pot further comprises a second frame (93), wherein the second frame (93) comprises a second sidewall panel (89). The second sidewall panel (89) is joined to a second front-end wall panel (91). The second sidewall panel (89) also includes a projecting second handle panel (92).

As further shown in FIG. 20, the first and second frames (88, 93) also include lower (bottom) end panels (94). Each bottom panel (94) has a semi-circle cut-away section. The first and second rear-end wall panels can be snap-fitted together using a ball and socket mechanism or other suitable locking means. For example, the ball (112) can be inserted into the socket (114). Likewise, the first and second front-end wall panels (91) can be joined together by any suitable locking mechanism including, for example, a ball (112) and socket (114) locking mechanism as shown in FIG. 20. hinge (95). Thus, when the split-pot (87) is closed by pressing the first and second front end-wall panels (91) and the first and second rear-end wall panels towards each other so that they make contact, the bottom panel has a full circle cut-out section. The split-pots (87) can have elongated openings in their wall panels for air pruning. These openings help promote root growth downwardly through the circular cut-out section of the bottom panel.

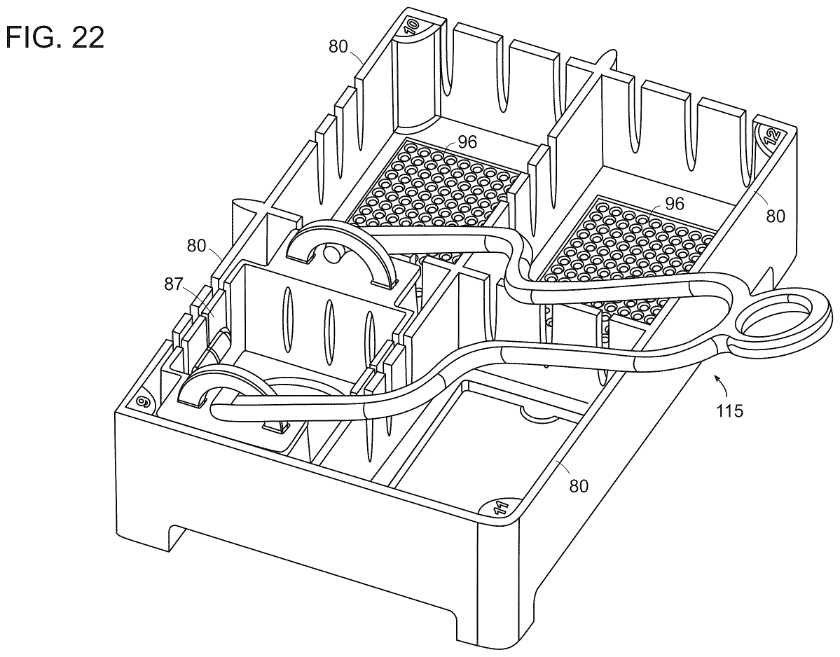

Referring to FIG. 21A, another embodiment of a split-pot handling tool (115), which can be used for handling the split-pots (87) in the tray (85), is shown. The split-pot handling tool (115) includes end pieces with extending posts (122). The first arm of the handling tool (115) includes a generally linear segment (120) joined to a curved segment (118), which is joined to a second generally linear segment (116) so that the arm has a Z-shaped configuration. The second arm is a mirror-image of the first arm and also includes a generally linear segment (120) joined to a curved segment (118), which is joined to a second generally linear segment (116) so that the arm has a S-shaped configuration. The arms are joined at connecting segment (124) which includes an extending handle portion (125). As shown in FIG. 22, the split-pot handling tool (115) can be used for handling the split-pots (87) in the tray (85).

The tray assemblies of the present invention provide many benefits and advantages. As discussed above, one key feature is that the tray assemblies provide an effective means for labeling and organizing the seeds and resulting plants. Multiple varieties of seeds can be planted in the trays; and the different seeds/plants can be kept well organized. The tray assemblies are effective at regulating temperature and moisture conditions. The tray assemblies provide an optimum environment for germinating a variety of seeds at one time in a single container. The tray systems provide excellent conditions from storage to germination to seedling and plant propagation.

It should be understood the terms, “first”, “second”, “third”, “fourth”, “fifth”, “sixth” “seventh”. “eighth”, “top”, “bottom”. “inner”, “outer”, “below”, “above”. “upper”, “lower”, “upward”, “downward”, “right”, “left”, “anterior”, “posterior”, and the like are arbitrary terms used to refer to one position of an element based on one perspective and should not be construed as limiting the scope of the invention.

It should again be understood that the tray assemblies and systems for plant seed germination and growth, components of the tray assemblies, constructions, materials, methods, techniques, and the like described an illustrated herein represent only some embodiments of the invention. The tray assemblies and systems for plant seed germination and growth, components of the tray assemblies, constructions, materials, methods, and the like of the invention are not intended to be limited to the particular examples and embodiments disclosed herein. It is intended that all examples and embodiments, which fall within the true spirit and scope of the invention, be covered by the appended claims.

We claim:

1. A tray assembly for plant seed germination and growth, the assembly comprising:
an outer tray having a first bottom portion and first outer perimeter wall;
an inner tray having a second bottom portion and second outer perimeter wall, the inner tray being disposed in the outer tray so that the second bottom portion of the inner tray contacts the first bottom portion of the outer tray and the first outer perimeter wall of the inner tray contacts the second outer perimeter wall of the outer tray; and
an inner divider frame, the inner divider frame being disposed in the inner tray, the inner divider frame having a plurality of dividers, wherein the dividers are joined to a hub connector, the dividers forming a plurality of compartments across the frame, each compartment configured to receive at least one seed for germination and growth.

2. The tray assembly of claim 1, wherein bottom portion of the inner tray contains openings for allowing air and water to permeate through the bottom portion.

3. The tray assembly of claim 1, wherein the dividers contain openings for allowing air and water to permeate between the compartments.

4. The tray assembly of claim 1, wherein the inner tray comprises a set of projecting foot segments for supporting the inner tray.

5. The tray assembly of claim 1, wherein the outer tray comprises a male member; and the inner tray comprises a counterpart notch, the male member being adapted for inserting into the notch so that the outer tray and inner tray are locked.

6. The tray assembly of claim 1, wherein the male member and notch are V-shaped.

7. The tray assembly of claim 1, wherein the divider frame comprises a pin and the inner tray comprises an indentation, the pin being adapted for inserting into the indentation so that the divider frame and inner tray are locked.

8. The tray assembly of claim 1, wherein there are eight compartments across the frame.

9. The tray assembly of claim 1, wherein there are six compartments across the frame.

10. The tray assembly of claim 1, wherein the compartments are labeled with different indicia for organizing the seeds in the compartments.

11. The tray assembly of claim 10, wherein the compartments include projecting column members and the column members are labeled with different indicia for organizing the seeds in the compartments.

12. The tray assembly of claim 1, wherein the tray assembly further comprises a cover for placing over the divider frame.

13. The tray assembly of claim 1, wherein the cover comprises protruding segments, and there are channels located between the protruding segments so that a first tray assembly can be stacked on a second tray assembly.

14. The tray assembly of claim 1, wherein the outer tray contains an outer perimeter base on its exterior surface, the base projecting outwardly from the bottom portion of the outer tray so that a first tray assembly can be stacked on a second tray assembly.

15. The tray assembly of claim 12, wherein the outer tray, inner tray, and inner divider frame, and cover are circular-shaped.

16. A tray assembly for plant seed germination and growth, the assembly comprising:
an outer tray having a first bottom portion and first outer perimeter wall; and
an inner tray having a second bottom portion and second outer perimeter wall, the inner tray being disposed in the outer tray so that the second bottom portion of the inner tray contacts the first bottom portion of the outer tray and the first outer perimeter wall of the inner tray contacts the second outer perimeter wall of the outer tray.

17. The tray assembly of claim 16, wherein there are multiple inner trays disposed in the outer tray, each inner tray having at least one compartment for seed germination and growth.

18. The tray assembly of claim 16, wherein there are four inner trays disposed in the outer tray, and each inner tray contains four compartments.

19. The tray assembly of claim 18, wherein the bottom portion of each compartment is removable.

20. The tray assembly of claim 18, wherein the inner tray and outer tray are rectangular-shaped.
